(19) United States
(12) Patent Application Publication
(10) Pub. No.: US 2026/0257880 A1
(43) Pub. Date: Sep. 3, 2026

(54) METHOD AND MACHINE FOR FOLDING SHEETS

(71) Applicant: G.D S.p.A, Bologna (IT)

(72) Inventors: Giuliano GAMBERINI, Bologna (IT); Mirco LEGNANI, Bologna (IT)

(21) Appl. No.: 19/154,548

(22) PCT Filed: Feb. 5, 2024
(86) PCT No.: PCT/IT2024/050028

§ 371 Date: Aug. 7, 2025

(30) Foreign Application Priority Data
Feb. 10, 2023 (IT) 102023000002328

(51) Int. Cl. B65H 45/14; B31D 5/04; B65H 5/02; B65H 7/00; B65H 29/16; B65H 45/16; B65H 45/18

(52) U.S. Cl. CPC B65H 45/147; B31D 5/04; B65H 5/021; B65H 7/00; B65H 29/16; B65H 45/16; B65H 45/18; B65H 2301/452; B65H 2801/81

(57) ABSTRACT

Method, and machine (1), for folding sheets (F), the machine (1) comprising a linear transport system (2) comprising a linear fixed guide (3) defining a treatment path, and a plurality of support elements (4) slidingly engaging the fixed guide (3), wherein the linear transport system (2) is structured for moving each support element (4) of said plurality of support elements (4) slidingly along the fixed guide (3) independently from the remaining support elements (4), and wherein the method comprises the steps of: arranging a sheet (F) on holding onto the plurality of support elements (4); moving the plurality of support elements (4) along the treatment path; making one or more folds (P) on the sheet (F), each fold (P) being made by reciprocally approaching, along the treatment path, two respective support elements (4) directly consecutive.

### TECHNICAL FIELD OF THE INVENTION

The present invention relates to a method and machine for folding sheets, e.g. sheets of paper or cardboard, polymer material, metal material.

### STATE OF THE ART

In the packaging sector, the need is felt for one or more folds to be made on a sheet, typically made of paper/cardboard or plastic material. For instance, when it is necessary to securely place a plurality of objects, for instance ampoules, disposable spare parts (e.g. cartridges, electric toothbrush heads, etc.), within a larger container, it is known to insert a folded insert into such containers which, thanks to its folds, has accommodation compartments for this plurality of objects (e.g. a compartment for each object or a pair of objects). Typically, the insert is made by folding from a flat sheet.

In this context, machines for folding flat sheets are known.

### SUMMARY OF THE INVENTION

By the expression ‘linear guide’ it is meant a guide having line of main development (i.e. the physical dimension along which the guide predominantly develops) that extends in a plane or in the three-dimensional space with any form, e.g. by combining straight stretches, curved stretches, flat stretches, ascending, descending, horizontal, vertical stretches, etc. Typically, such a line of main development (in use traversed by the support elements with a given direction) identifies a treatment path.

The expression “arranging a sheet on holding” it is meant blocking two or more portions of the sheet on respective support elements (preferably on all the support elements) to prevent a mutual movement between said portions of the sheet and said respective support elements at least during the folding (typically also during sheet handling).

By the terms “perpendicular” and “orthogonal” it is meant respectively a substantial perpendicularity and orthogonality between two elements, comprising both the ideal case in which these elements are arranged with respect to one another to form a right angle, and more frequent cases in which the two elements are arranged with respect to one another to form an angle that deviates from the right angle (e. g. within an interval of +−15°, more preferably +−10°, with respect to the right angle) but in any case negligible or irrelevant to the operation of the present solution.

Two elements are considered to be “directly consecutive” when are positioned one after the other without the interposition of any further element (of the same nature).

With reference to the treatment path, a first station is considered ‘upstream’ of a second station when said first station precedes the second station, conversely, the second station is considered ‘downstream’ of the first station as it follows the first station.

The Applicant has noted that the known folding machines have some drawbacks and can be improved under one or more respects.

For instance, the Applicant has noted that the known folding machines results structurally complex as well as expensive to implement.

Moreover, such known folding machines typically have a large footprint, especially in plain view.

The Applicant has therefore addressed the problem of performing automatic folding of sheets easily, quickly, economically and/or with reduced machine footprint.

According to the Applicant the aforesaid problem is solved by a method, and a machine, for folding sheets according to the attached claims and/or having one or more of the following features.

According to one aspect, the invention relates to a method for folding sheets.

Preferably said method comprises providing a linear transport system. Preferably said linear transport system comprises a linear fixed guide that more preferably defines a treatment path.

Preferably said linear transport system comprises a plurality of support elements slidingly engaging said fixed guide. Preferably said linear transport system is structured for moving each support element of said plurality of support elements slidingly along said fixed guide independently from the remaining support elements of said plurality of support elements.

Preferably said method comprises arranging a sheet on holding onto said plurality of support elements.

Preferably said method comprises moving said plurality of support elements along said treatment path.

Preferably said method comprises making one or more folds on said sheet, each fold being made by reciprocally approaching, along said treatment path, two respective support elements directly consecutive.

According to another aspect, the invention relates to a machine for folding sheets.

Preferably said machine comprises the aforesaid linear transport system.

Preferably said machine comprises a control unit connected to said linear transport system.

Preferably said control unit is configured for moving said plurality of support elements along said treatment path.

Preferably said control unit is configured for commanding at least two support elements directly consecutive for reciprocally approaching, along said treatment path, said at least two support elements directly consecutive.

According to the Applicant the use of the linear transport system structured for moving each support element along the linear fixed guide independently from the remaining support elements, allows the sheet to be folded in a constructively simple, fast, economical way and with reduced footprint.

In fact, the possibility of independently controlling the movement of each support element along the guide (e.g. by precisely controlling a respective law of motion of each support element) allows the folds to be made without the need for complex handling systems of, and/or synchronism systems between, the various support elements, while keeping the machine structurally simple. Moreover, the Applicant has noted that by means of the above-mentioned linear transport system, may it be sufficient to reciprocally approach the respective support elements in order to make the folds of the sheet, making the provision of folding elements and related actuation systems superfluous.

Furthermore, thanks to the aforesaid linear transport system it is possible to execute, with the same machine, different folding programmes e.g. several folds at the same time or in time sequence, to the advantage of reduced time as well as structural simplicity and versatility.

The use of a linear transport system with a linear fixed guide and sliding support elements also makes it possible to keep the footprint of the machine limited (which can substantially coincide with the footprint of the linear guide), as well as to prepare the machine to be easily integrated into a continuous production line, wherein for example the folded sheet, still on holding onto the support elements, can continue to further stations.

The present invention in one or more of said aspects may have one or more of the following preferred features.

Preferably said machine comprises a loading station, more preferably structured for loading said sheet onto said plurality of support elements.

Preferably arranging a sheet on holding onto said plurality of support elements comprises exerting an holding action onto said sheet by means of at least two support elements of said plurality of support elements. In similarly preferred way, arranging a sheet on holding onto said plurality of support elements comprises exerting an holding action onto said sheet by means of all the support elements of said plurality of support elements.

Preferably making said one or more folds is performed by keeping said plurality of support elements in movement along said treatment path with same movement direction. Preferably said movement is continuous. In other words, the support elements never stop along treatment path during the making of the folds (but only undergo accelerations and/or decelerations in order to reciprocally approach directly consecutive support elements). In this way, by advantageously exploiting the possibility of controlling each support element independently from the others, the cycle time is limited.

Preferably reciprocally approaching said two respective support elements directly consecutive comprises varying a respective speed of movement of at least one of said two respective support elements. Preferably varying said respective speed comprises at least one of slowing down a support element of said two respective support elements arranged further downstream along said treatment path and accelerating a support element of said two respective support elements arranged further upstream along said treatment path. In this way, the approach is achieved in a simple and easily controllable manner.

Preferably said method comprises making a plurality of folds by reciprocally approaching support elements of each respective pair of directly consecutive support elements. Preferably said method may comprise making a plurality of folds in time sequence by reciprocally approaching support elements of each respective pair of directly consecutive support elements. Equally preferably, said method may comprise making a plurality of folds by simultaneously reciprocally approaching support elements of each respective pair of directly consecutive support elements. In other words, the folds may be made in time sequence or all simultaneously with each other.

Preferably said machine comprises a folding station, more preferably arranged downstream of said loading station.

Preferably making said one or more folds on said sheet is performed at a folding station along said treatment path.

For example, the folding station comprises a section of the fixed guide at which the fold(s) of the sheet takes place.

Preferably said folding station comprises at least one folding plane. In one embodiment, said folding station comprises only one folding plane.

Preferably said folding plane is incident to said treatment path (e.g. incident to the movement direction of the support elements). More preferably, said folding plane is perpendicular to said treatment path (e.g. perpendicular to the movement direction of the support elements). The folding plane represents, for example, a virtual plane on which a fold of the sheet takes place. Such folding plane may, for instance, be a single plane for all folds (if, for instance, they take place in time sequence at the same point), or there may be provided a plurality of mutually parallel planes, each for one or more respective folds. Furthermore the folding plane may be spatially fixed with respect to the fixed guide, or it may be movable (e.g. if the fold is made with the support elements in motion, the folding plane moves along the

Preferably said machine comprises one or more folding elements.

Preferably said method comprises arranging one or more folding elements.

Each folding element is preferably alternately movable from one or more distal positions distal from said fixed guide to a proximal position proximal to said fixed guide wherein said folding element lies onto said folding plane. The folding elements may facilitate the folding, as better described below.

Preferably each folding element is provided with an operating end for making said one or more folds on said sheet.

Preferably, when a respective folding element is in said one or more distal positions, said operating end is distant from said fixed guide by a first distance and, when said respective folding element is in said proximal position, said operating end is distant from said fixed guide by a second distance less than said first distance.

Preferably making said one or more folds on said sheet comprises, for each fold, performing in the order the steps of:
i) arranging said two respective support elements in proximity, and respectively upstream and downstream, of said folding plane along said treatment path;
ii) moving a respective folding element of said one or more folding elements from one of said one or more distal positions to said proximal position, to bringing into contact said respective folding element with said sheet;
iii) bringing said respective folding element back to one of said one or more distal positions.

The folding element, by contacting the sheet, contributes advantageously to the making of the folds, e.g. by pointing the sheet in the right direction.

Preferably said control unit is configured for:
i) arranging said two support elements in proximity, and respectively upstream and downstream, of said folding plane along said treatment path;
ii) moving a respective folding element from one of said one or more distal positions to said proximal position for bringing into contact said respective folding element with a sheet;
iii) bringing said respective folding element back to one of said one or more distal positions.

In one embodiment arranging said one or more folding elements comprises arranging a plurality of folding elements radially protruding from a common support rotating about an axis of rotation. Preferably said one or more folding elements comprise, more preferably consist of, a plurality of folding elements radially protruding from a common support rotating about an axis of rotation.

Preferably said axis of rotation is perpendicular to the treatment path. Alternatively said axis of rotation is parallel to the treatment path. Preferably moving said respective folding element comprises rotating said common support. In this way the making of the folds is facilitated in rapid way, even in continuous.

In one embodiment moving said respective folding element comprises moving said respective folding element along a trajectory perpendicular to said fixed guide, more preferably purely perpendicular to said fixed guide. Preferably each of said one or more folding elements is movable along said trajectory. In this way the machine is maintained structurally simple and compact.

In this embodiment, preferably said one or more folding elements comprise one and only one folding element. In this way the encumbrances are limited.

Preferably reciprocally approaching said two respective support elements comprises moving both said two respective support elements towards each other. Preferably said method comprises, simultaneously to said reciprocally approaching said two respective support elements, moving each remaining support element rigidly with a respective support element of said two respective support elements arranged on the same side with respect to said folding plane.

Preferably arranging said two respective support elements comprises rigidly moving all said support elements along said treatment path. In this way the making of the folds is facilitated.

Preferably arranging said sheet on holding comprises applying one or more of the following techniques: suction of said sheet by vacuum application, electro-adhesion, hooking by means of mechanical locking members.

Preferably said machine comprises a coupling station, more preferably arranged downstream of said folding station along said treatment path, structured for coupling a support layer to said sheet arranged on holding onto said plurality of support elements.

Preferably said method comprises, subsequently to said making said one or more folds, coupling a support layer to said sheet to make an insert, more preferably maintaining said sheet on holding onto said plurality of support elements.

Preferably coupling said support layer comprises gluing said support layer onto said sheet at portions of said sheet resting on said support elements. In this way strength of the insert is improved.

Preferably said method comprises, more preferably previously to coupling said support layer to said sheet, applying on at least one between said sheet and said support layer, a label and/or an adhesive. Preferably said label and/or adhesive are of the Acousto-Magnetic (AM) or Radio Frequency (RF) type.

Preferably said method comprises, subsequently to said making said one or more folds, moving said sheet (more preferably said insert) along said treatment path to an unloading station arranged along said fixed guide. Preferably said method comprises unloading said sheet (more preferably said insert) from said plurality of support elements at said unloading station. In one embodiment, at said unloading station said sheet (more preferably said insert) is rotated by 180° with respect to said sheet at said folding station.

Preferably said machine comprises an unloading station, more preferably arranged downstream of said folding station (even more preferably downstream of said coupling station) along said treatment path. Preferably said unloading station is structured for unloading said sheet (more preferably said insert) from said plurality of support elements. In one embodiment, said fixed guide is shaped so that said sheet, when in said unloading station, is rotated by 180° with respect to said sheet when in said folding station. Preferably said folding station and said unloading station are at a same height. Alternatively, said folding station is at a higher height than said unloading station. Preferably said fixed guide is shaped so that said sheet is substantially horizontal when in said unloading station. In this way it is facilitated the unloading of the sheet into the unloading station, as it is favourably arranged to be separated from said support elements by dropping.

Preferably said fixed guide has said line of main development as a closed-loop line of main development. In this way it is enhanced the efficiency of the machine.

Preferably each support element comprises a respective carriage, engaging said fixed guide. Preferably each support element comprises, at opposite side of said respective carriage with respect to said fixed guide, a respective support arm. Preferably each support arm is integral to the respective carriage and more preferably it is structured for supporting and holding said sheet. In this way the support elements are structurally simple. Preferably each support arm has elongated shape which extends in a direction perpendicular to said treatment path.

Preferably each support element comprises a respective independent drive unit. In this way the possibility of moving each support element along the fixed guide independently from the others is realized in structurally simple way.

Preferably said linear transport system comprises a sub-system of contactless communication (e.g. transmission and/or reception) of a signal (e.g. power signal and/or data signals) between said fixed guide and each support element (more preferably the respective drive unit and/or a respective processing unit incorporated on the support element) and/or vice versa. For instance the signals may be reciprocally transmitted by inductive coupling between one or more stationary coils arranged on the fixed guide with one or more coils arranged on each of the support elements. In this way, the coupling is simple, direct, free from friction (and thus free from problems related to wear of the parts), and capable of permitting reciprocal transmission of signals both with the support elements stationary and in motion along the guide.

Preferably each drive unit is structured for being operated (e.g. powered and/or controlled) by said sub-system of communication, more preferably by said control unit.

Preferably said line of main development lies on a (substantially) vertical lying surface. In this way the encumbrances in plain view are further limited.

Preferably each respective support arm develops away from said fixed guide, more preferably parallelly to said lying surface. Alternatively, each respective support arm develops perpendicularly to said lying surface (e.g. horizontally). In this way it is limited the possible interference between the sheet and the guide during folding operations, for example when in presence of one or more folding elements.

It should be noted that some of the steps of the method described above may be independent from the reported order of execution, except where a sequentiality or simultaneity between two or more steps is expressly indicated as necessary. Moreover, some steps may be optional. Moreover, some steps may be performed repetitively, or they may be performed in series or in parallel with other steps of the method.

### BRIEF DESCRIPTION OF THE DRAWINGS

FIG. 1 shows a scheme of a machine according to a first embodiment of the present invention;

FIG. 2 shows a scheme of a machine according to a second embodiment of the present invention;

FIG. 3 shows a scheme of a machine according to a third embodiment of the present invention;

FIG. 4 schematically shows a perspective view of a detail of a machine according to the present invention;

FIGS. 5-7 schematically show a respective top view of a detail of a machine according to different embodiments of the present invention;

FIGS. 8-10 schematically show some steps of a method for folding according to one embodiment of the present invention;

FIGS. 11-14 schematically show some steps of a method for folding according to a further embodiment of the present invention.

### DETAILED DESCRIPTION OF CERTAIN EMBODIMENTS OF THE INVENTION

The features and the advantages of the present invention will be further clarified by the following detailed description of some embodiments, presented by way of example and not limitation of the present invention, with reference to the attached figures.

In the following description, the same numerical references will be used to identify similar elements, even in their different embodiments.

In the figures, with number 1 it is generally indicated a machine for folding sheets F. For example, the sheets to be folded can be made of paper material (paper, cardboard), polymeric material, metallic material.

Exemplarily the machine 1 comprises a linear transport system 2, exemplarily comprising a linear fixed guide 3 which defines a treatment path. Exemplarily the linear transport system 2 further comprises a plurality of support elements 4 slidingly engaging the fixed guide 3.

Exemplarily the machine 1 comprises a control unit 10 connected to the linear transport system 2, and configured for moving the plurality of support elements 4 along the treatment path.

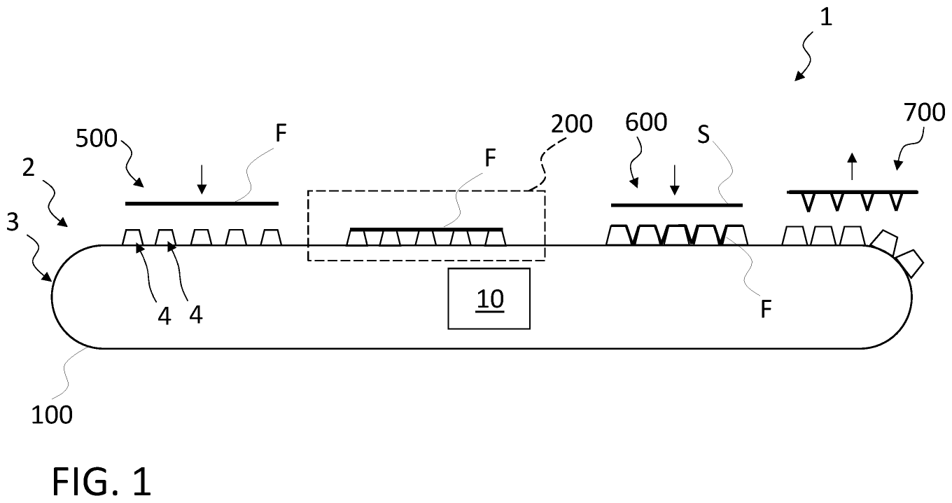

In FIGS. 1 to 3, the fixed guide 3 is exemplarily represented in purely schematic way by a line representing its line of main development 100 (i.e. the line along which the major physical dimension of the guide develops). This line of main development 100, traversed in a predetermined direction of motion by the support elements 4 (clockwise in the figures), identifies the aforesaid treatment path. Exemplarily the line of main development 100 has closed loop, so that support elements can recirculate continuously along the guide to perform several successive folding cycles. For simplicity of depiction, the line of main development 100 is shown lying entirely on a vertical lying plane (in the FIGS. 1-3 coincident with the plane of the figure).

In the not shown embodiments, the line of main development 100 may have any development in the space. In such embodiments, the line of main development may entirely lie on a vertical lying surface. In other words, opposing portions of the fixed guide, representing respectively a forward and a return stroke of the supporting elements, are, at each point of the guide, reciprocally vertically overlapping.

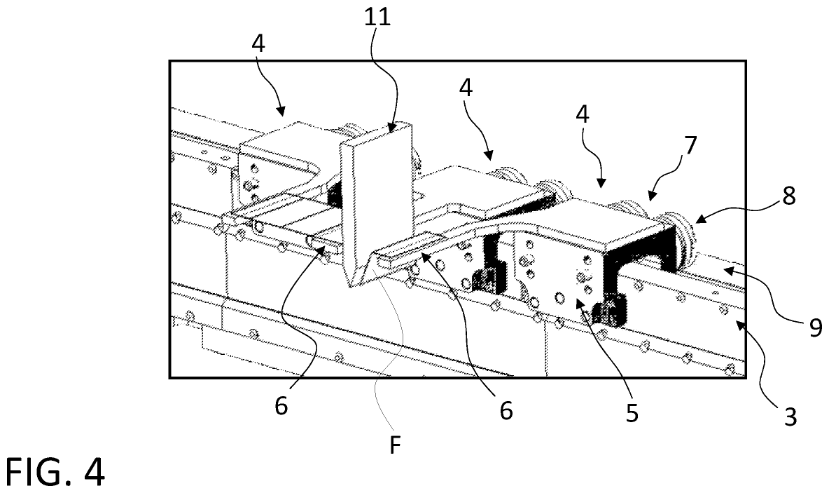

Exemplarily (FIG. 4-7) each support element 4 comprises a respective carriage 5, engaging the fixed guide 3, and, at opposite side of the respective carriage 4 with respect to the fixed guide 3, a respective support arm 6.

Exemplarily each support arm 6 is integral with the respective carriage and structured to support and hold a sheet to be folded (as further described below).

Exemplarily each respective support arm 6 extends away from the fixed guide 3, perpendicularly to the lying surface of the guide. In a not shown embodiment, each respective support arm 6 extends away from the fixed guide 3, parallelly to the lying surface.

Exemplarily each support element 4 comprises a respective independent drive unit 7. For example, the drive unit 7 may comprise one or more rollers 8 (FIG. 4) in rolling contact with a sliding surface 9 of the fixed guide 3.

Exemplarily (not shown), the linear transport system 2 comprises a sub-system of contactless communication (e.g. transmission and/or reception) of a signal (e.g. power signal and/or data signals) between the fixed guide 3 and each support element 4 (exemplarily the respective drive unit 7 and/or a respective processing unit embedded on the support element, not shown) and vice versa. For example (not shown) the power and data signals may be reciprocally transmitted by inductive coupling between one or more stationary coils arranged on the fixed guide with one or more coils arranged on each of the support elements.

Exemplarily each drive unit 7 is structured to be operated (e.g. powered and/or controlled) by means of the sub-system of communication, by a control unit 10 of the machine 1 (to this regard, respective processing units possibly arranged on board the carriages 5 of the support elements can be conceptually considered as being part of the control unit 10 of the machine, as they are typically connected to it, for example by means of the said system of communication).

For example, the linear transport system 2, as such, can be of the type described in US2021/0046826 A1, as far as compatible herewith.

With reference to the FIGS. 1 to 3, the machine shown therein exemplarily comprises a folding station 200 (delimited in purely schematically way by the dashed rectangle shown in the aforesaid figures). The folding station corresponds to a portion of the treatment path at which one or more folds of the sheet are made, irrespective of the adopted embodiment of the method for folding (see below).

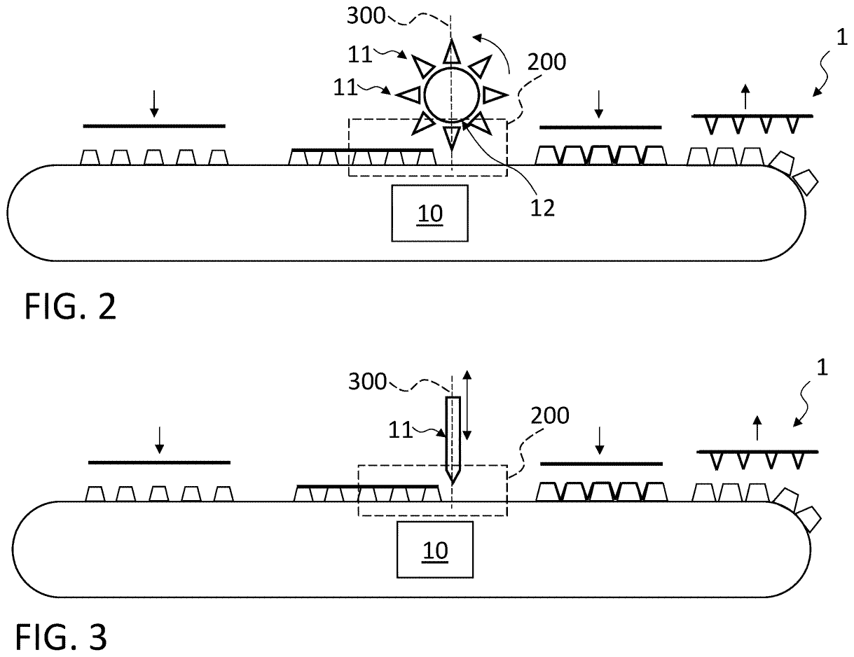

In such folding station 200, it is exemplarily defined a folding plane 300, exemplarily shown by a dotted line in FIGS. 2 and 3, 9,10 and 11-14.

In the embodiment of FIG. 1, the machine is exemplarily devoid of folding elements. In such configuration, the folds are made by reciprocal movement of the only support elements (as better described below). Although not shown, also in this embodiment it is possible to defined one (or more) folding planes.

In the embodiment of FIG. 2, the machine 1 exemplarily comprises a plurality of folding elements 11 radially protruding from a common support 12 rotating about an axis of rotation (exemplarily perpendicular to the plane of the sheet of the figures). Exemplarily each folding element 12, rotating about said axis of rotation, results movable alternatively from several distal positions distal from the fixed guide to a proximal position proximal to the fixed guide in which it lies on the folding plane 300.

In the embodiment of FIG. 3, the machine 1 exemplarily comprises one and only one folding element 11 movable along a purely vertical trajectory alternatively from a distal position distal to the fixed guide (FIGS. 3, 11, 13), to a proximal position proximal to the fixed guide (FIG. 14). Exemplarily the aforesaid purely vertical trajectory entirely lies on the folding plane 300.

The linear transport system 2 may, for example, comprise one or more further pluralities of support elements slidingly engaging a same fixed guide 3 simultaneously with the said plurality of support elements.

For example, in FIGS. 1-3 there are shown four distinct pluralities of support elements simultaneously engaging the same fixed guide 3 at different portions of the treatment path (corresponding to different phases of the method for folding according to the present invention, as better described below). Alternatively, the four distinct pluralities of support elements shown in FIGS. 1-3 may also be interpreted as the same plurality of support elements 4 depicted at different phases of the method.

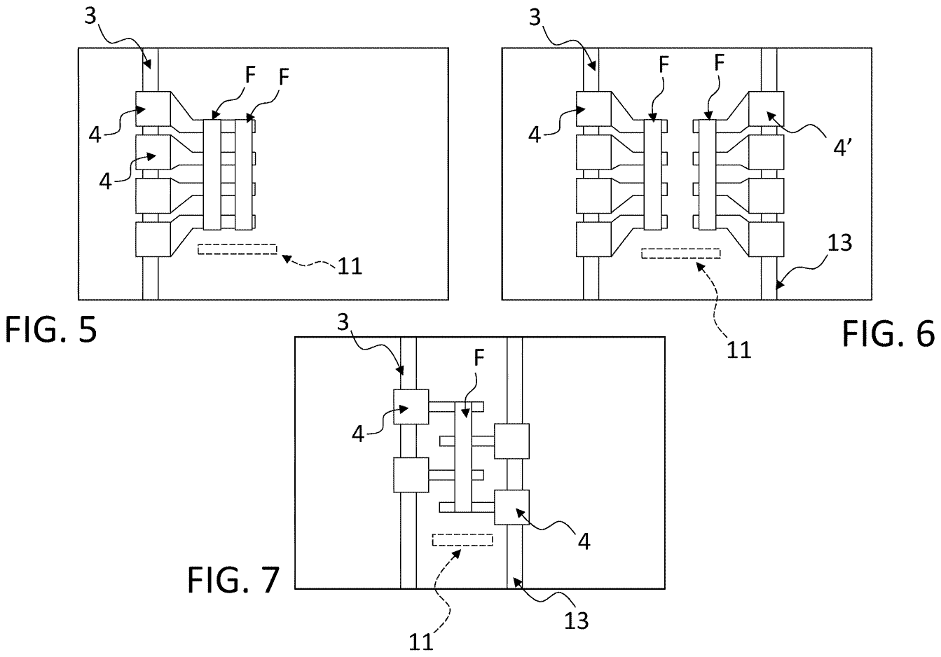

With reference to FIG. 5, in the embodiment shown, the support arms 6 of the support elements 4 are exemplarily dimensioned to simultaneously support two separate sheets (to be folded simultaneously), or (not shown) a single sheet with double width. Such configuration of the support arms results advantageous in order to easily adapt the machine to different sheet formats to be folded.

In another embodiment, FIG. 7, the linear transport system 2 comprises a further linear fixed guide 13, wherein the plurality of support elements 4 is distributed alternately between the two guides with the respective support arms 6 reciprocally facing to support a common sheet to be folded. Such embodiment can also be advantageous to adapt the machine to a variation in sheet format, while limiting the overhanging extension of the support arms 6.

FIG. 6 shows a further embodiment, in which the linear transport system 2 is doubled into two lines, each comprising a respective linear fixed guide 3, 13 and a respective plurality of support elements 4, 4′ to the advantage of higher productivity.

FIGS. 5-7 schematically show a respective (optional) folding element 11 (dashed rectangle).

In the embodiment of FIG. 6, the folding element 11 can be in common with the two lines.

Each folding element (optional) shown in FIGS. 5-7 can belong to one of the two aforementioned types (i.e. plurality of folding elements with common rotating support or a single folding element).

The machine exemplarily comprises (FIGS. 1-3), a loading station 500 upstream of the folding station 200, a coupling station 600 downstream of the folding station 200, and an unloading station 700 downstream of the coupling station 600.

In use, the machine 1 allows to perform a method for folding a sheet F.

Exemplarily the method initially comprises arranging the sheet F on holding onto the plurality of support elements 4 in the loading station 500. The holding of the sheet can be achieved by two or more (preferably all) of the support elements, exemplarily at the support arms 6, for example by means of one or more of the following techniques (the respective apparatuses enabling the making thereof are not shown, as they are, for example, of known type): suction of said sheet by vacuum application, electro-adhesion, hooking by means of mechanical locking members (e.g. grippers, micro-actuators, piezoelectric members, etc.). By electro-adhesion it is meant the ability to attract a material towards a surface by generating reversible electric fields to which the material is subjected at that surface.

Exemplarily the method thus comprises moving the plurality (or each plurality) of support elements 4 along the treatment path.

Exemplarily the method comprises, along the treatment path (exemplarily in conjunction with the transit of the support elements in the folding station 200), making one or more folds P on the sheet F (exemplarily a fold P for each couple of directly consecutive support elements 4), each fold P being made by reciprocally approaching two respective support elements 4 directly consecutive. Exemplarily the control unit 10 is configured for commanding each support element 4 for reciprocally approaching each pair of support elements 4 directly consecutive to make the aforesaid folds.

Exemplarily (see for example FIG. 9-10, 12-14), each fold P is made by folding the sheet along at least three distinct folding lines, preferably parallel to each other and all perpendicular to the direction of motion of the sheet F along the treatment path.

Exemplarily, the linear transport system 2 is structured for moving each support element 4 slidingly along the fixed guide 3 independently from the remaining support elements 4, for example by means of the aforesaid drive units 7 and the sub-system of communication and by means of the control unit 10. Thanks to the independent movement of each support element, the making of the folds can advantageously be made in a variety of ways, with structural simplicity of the machine.

In one embodiment, making one or more folds can be performed keeping the plurality of support elements 4 moving along the treatment path with same direction of motion. In other words, the support elements 4 never stop along the treatment path during the make of the folds.

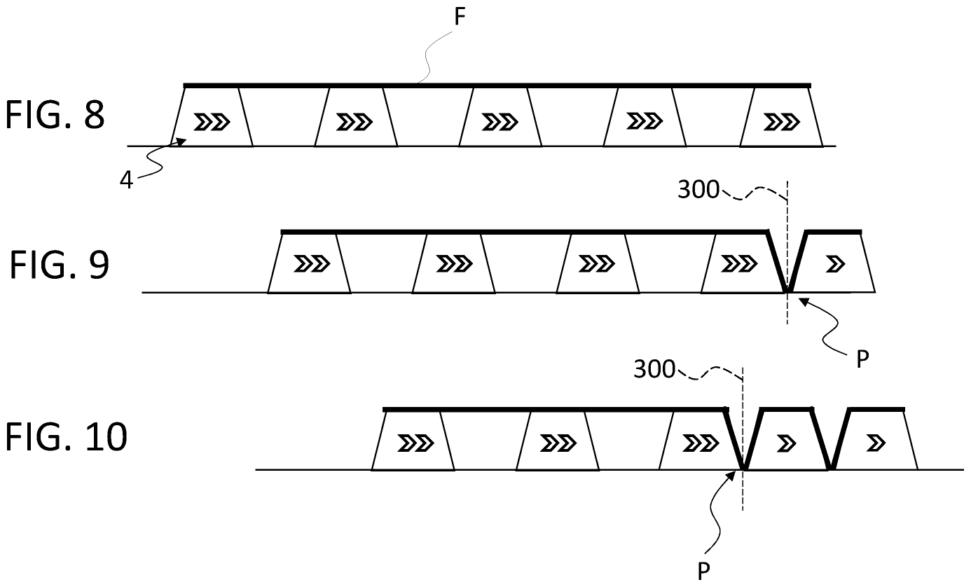

Such a situation is schematically shown in FIGS. 8-10.

FIG. 8 indicatively shows the plurality of support elements 4 moving along the fixed guide, all with the same speed (e.g. constant with same trajectory and direction, symbolised by the double arrows), and all at a same mutual distance, so that the sheet F is at rest (e.g. not stretched or folded) on the support elements.

In such embodiment, reciprocally approaching the two respective support elements directly consecutive exemplarily comprises varying a respective movement speed of at least one of the two respective support elements, e.g. slowing down a support element placed further downstream along the treatment path.

By appropriately adjusting the laws of motion of each support element 4 independently from each other, it is possible to make the desired folds all at the same time or in time sequence. This second case is shown in FIGS. 9 and 10 below.

In FIG. 9, exemplarily, the support element 4 arranged further to the right with respect to the plurality (i.e. the support element arranged further downstream) has undergone a deceleration (as shown by the single arrow), with the directly consecutive support element 4 (the element directly further upstream) that, having maintained constant its initial speed, has reduced its distance from the further downstream support element, making a first fold on the sheet F.

FIG. 10 exemplarily shows a subsequent phase, wherein the second support element 4 was also slowed down starting from the right (as shown by the single arrow), with the third support element 4 that maintains its speed by making a second fold, and so on.

In such embodiment, the folding plane 300 can actually be multiple (e.g. if the folds are performed simultaneously) and generally moving along the fixed guide 3.

Exemplarily, the machine 1 according to the embodiment shown in FIGS. 1 and 2 can advantageously be adapted for the making of the folds without the complete stop of the support elements 4.

In case, as shown in FIG. 2, of presence of the plurality of folding elements 11, the common support 12 is rotated, exemplarily counterclockwise, synchronously with the motion of the support elements 4 so that each folding element 11 contacts, in turn, the sheet F at the transition of the support elements 4 substantially inferiorly to the common support.

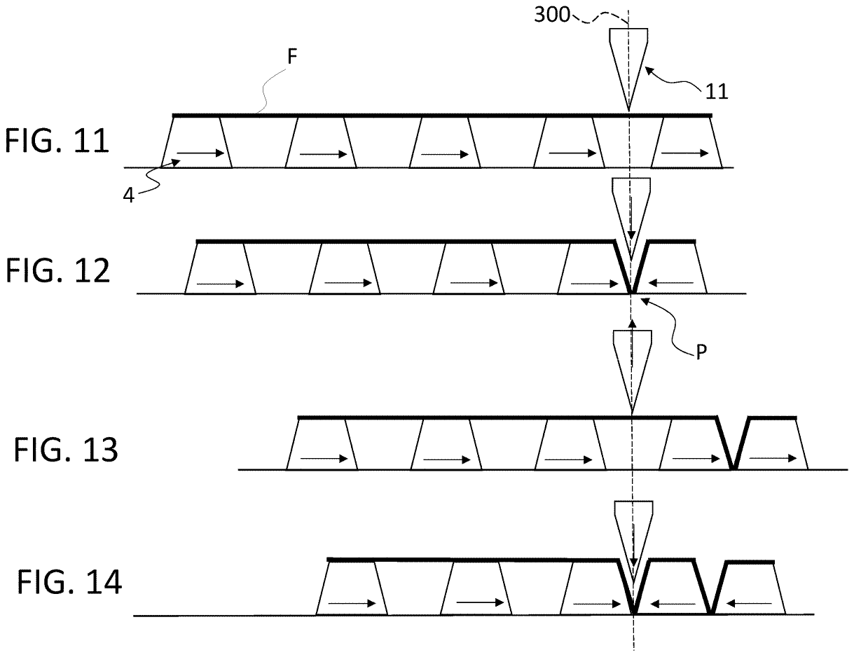

In one embodiment, the folds can be made by stopping the plurality of support elements 4 in the folding station 200, for example when a single folding element 11 movable along a purely vertical trajectory is present. Such situation is exemplarily shown in FIG. 3, as regards a general scheme of the machine, and in FIGS. 11-14 with respect to some salient steps of the make of the folds.

With reference to FIGS. 11-14, to make each fold it is exemplary provided:
i) arranging two respective support elements in proximity, and respectively upstream and downstream, of the folding plane 300 along the treatment path (FIGS. 11 and 13);
ii) moving the folding element 11 from the distal position to the proximal position, for bringing into contact the respective folding element with the sheet F (FIGS. 12 and 14);
iii) bringing the folding element 11 back to said distal position (FIG. 13).

Exemplarily reciprocally approaching the two respective support element is performed simultaneously with the movement of the folding element towards the proximal position, and comprises moving both the two support elements towards each other (FIGS. 12 and 14). Exemplarily the method comprises, simultaneously with reciprocally approaching the two respective support elements, moving each remaining support element 4 rigidly with a respective support element of the two respective support elements arranged at a same side with respect to the folding plane 300 (FIGS. 12 and 14). Exemplarily arranging two respective support elements at opposite sides of the folding plane comprises rigidly moving all the support elements along the treatment path (FIGS. 11 and 13).

The folding element 11 (or a respective folding element when in presence of the plurality of folding elements 11), in the respective movement from a distal position to the proximal position, may perform only a brief contact with the sheet (e.g. without going all the way down to the bottom of the fold) sufficient to direct the sheet in the correct folding direction, or substantially accompany the sheet all the way down for the whole useful height of the fold.

In addition to or alternatively to the folding elements, the sheet F (not shown) may also be subjected, prior to the method for folding, to a creasing process to prepare the sheet for the folds (typically the creasing is performed at the paper mill). For example, the creasing comprises making some grooves (e.g. by pressing with appropriate rollers) on a face of the sheet, eventually also making corresponding reliefs on the opposite face. Such creases facilitate the folding of the sheet (which typically takes place so that the concavity of the fold is at the same side as the groove made by the creasing).

In one embodiment, a folding element in the proximal position is in contact with the sheet at a sheet surface that does not comprise any creasing.

Exemplarily the method comprises, subsequently to making the one or more folds, coupling, at the coupling station 600, a support layer S to the sheet F while keeping the sheet (F) on holding onto the plurality of support elements 4 (FIG. 1-3), for making an insert. Exemplarily coupling the support layer S comprises gluing the support layer onto the sheet at portions (exemplarily mutually coplanar) of the sheet F resting on the support elements 4 (e.g. on the support arms 6).

Exemplarily, subsequently to the coupling with the support layer S, the sheet (the insert) is moved along the treatment path to the unloading station 700, where the insert is exemplarily unloaded from the plurality of support elements 4 (e.g. to be placed on a conveyor belt to carry the insert to further operating stations).

Exemplarily the sheet is substantially horizontal at the operating stations along the treatment path.

In one not shown embodiment, the sheet in the unloading station results upside down by 180° with respect to the sheet at the upper straight tract of the guide. In this way the unloading is simple, e.g. by dropping.

1. A method for folding sheets, said method comprising the steps of:
providing a linear transport system comprising a linear fixed guide defining a treatment path, and a plurality of support elements slidingly engaging said fixed guide wherein said linear transport system is structured for moving each support element of said plurality of support elements slidingly along said fixed guide independently from the remaining support elements of said plurality of support elements;
arranging a sheet on holding onto said plurality of support elements;
moving said plurality of support elements along said treatment path; and
making one or more folds on said sheet, each fold being made by reciprocally approaching, along said treatment path, two respective support elements directly consecutive.

2. The method according to claim 1, wherein making said one or more folds is performed by keeping said plurality of support elements in movement along said treatment path with same movement direction.

3. The method according to claim 2, wherein reciprocally approaching said two respective support elements directly consecutive comprises at least one of: slowing down a support element of said two respective support elements arranged further downstream along said treatment path and accelerating a support element of said two respective support elements arranged further upstream along said treatment path.

4. The method according to claim 1, comprising making a plurality of folds in time sequence by mutually approaching support elements of each respective pair of directly consecutive support elements.

5. The method according to claim 1, comprising simultaneously making a plurality of folds simultaneously reciprocally approaching support elements of each respective pair of directly consecutive support elements.

6. The method according to claim 1, wherein making on said sheet said one or more folds is performed at a folding station along said treatment path, wherein said folding station) comprises a folding plane incident to said treatment path, wherein said method comprises arranging one or more folding elements each folding element being alternatively movable from one or more distal positions distal from said fixed guide at a proximal position proximal to said fixed guide wherein said folding element lies onto said folding plane;
and wherein making on said sheet said one or more folds comprises, for each fold, performing in order the following steps:
i) arranging said two respective support elements in proximity, and respectively upstream and downstream, of said folding plane along said treatment path;
ii) moving a respective folding element of said one or more folding elements from one of said one or more distal positions to said proximal position, for bringing into contact said respective folding element with said sheet; and
iii) bringing said respective folding element back to one of said one or more distal positions.

7. The method according to claim 6, wherein arranging said one or more folding elements comprises arranging a plurality of folding elements radially protruding from a common support rotating about an axis of rotation, and wherein moving said respective folding element comprises rotating said common support.

8. The method according to claim 6, wherein moving said respective folding element comprises moving said respective folding element along a trajectory purely perpendicular to said fixed guide

9. The method according to claim 1, wherein arranging said sheet on holding comprises applying one or more of the following techniques: suction of said sheet by vacuum application, electro-adhesion, hooking by means of mechanical locking members.

10. A machine for folding sheets, said machine comprising:
a linear transport system comprising a linear fixed guide defining a treatment path, and a plurality of support elements slidingly engaging said fixed guide wherein said linear transport system is structured for moving each support element of said plurality of support elements slidingly along said fixed guide independently from the remaining support elements of said plurality of support elements and
a control unit connected to said linear transport system and configured for:
moving said plurality of support elements along said treatment path; and
commanding at least two support elements directly consecutive for reciprocally approaching, along said treatment path, said at least two support elements directly consecutive.

11. The machine according to claim 10, wherein said fixed guide has a closed-loop line of main development, wherein each support element comprises a respective carriage, engaging said fixed guide and a respective independent drive unit.

12. The machine according to claim 11, wherein said linear transport system comprises a sub-system of contactless communication of a signal between said fixed guide and each support element of said plurality and/or vice versa.

13. The machine according to claim 10, comprising one or more folding elements each folding element being alternatively movable from one or more distal positions distal from said fixed guide to a proximal position proximal to said fixed guide in which said folding element lies onto a folding plane incident to said treatment path, wherein said control unit is configured for:
i) arranging said two support elements in proximity, and respectively upstream and downstream, of said folding plane along said treatment path;
ii) moving a respective folding element from one of said one or more distal positions to said proximal position for bringing into contact said respective folding element with a sheet and
iii) bringing said respective folding element back to one of said one or more distal positions.

14. The machine according to claim 13, wherein said one or more folding elements consist of a plurality of folding elements radially protruding from a common support rotating about an axis of rotation.

15. The machine according to claim 13, wherein each of said one or more folding elements is movable along a trajectory purely perpendicular to said fixed guide.

16. The machine according to claim 10, comprising an unloading station structured for unloading a sheet from said plurality of support elements and wherein said fixed guide is shaped so that said sheet is substantially horizontal when in said unloading station.
